(19) United States
(12) Patent Application Publication
(10) Pub. No.: US 2025/0197585 A1
(43) Pub. Date: Jun. 19, 2025

(54) SYNTACTIC FOAMS

(71) Applicant: BAE SYSTEMS PLC, London (GB)

(72) Inventors: Megan Elizabeth Allpress, Barrow-In-Furness Cumbria (GB); Sean James Leighton, Barrow-In-Furness Cumbria (GB)

(73) Assignee: BAE SYSTEMS PLC, London (GB)

(21) Appl. No.: 18/847,862

(22) PCT Filed: Mar. 9, 2023
(86) PCT No.: PCT/GB2023/050558

§ 371 Date: Sep. 17, 2024

(30) Foreign Application Priority Data
Mar. 17, 2022 (GB) 2203694.1

(51) Int. Cl. C08J 9/32; C08J 7/04; C08J 9/228

(52) U.S. Cl. CPC C08J 9/32; C08J 7/0427; C08J 9/228; C08J 2201/022; C08J 2203/22; C08J 2363/00

(57) ABSTRACT

The present invention relates to the deposition of syntactic foams, more particularly to the formation of syntactic foam floatation devices for a vessel. There is provided a method of selectively depositing a syntactic foam, to provide a buoyancy device on a substrate, comprising the steps of:
i) selecting a low density polymer with a density in the range of from 0.8 to 1.2 g/cm³,
ii) forming an admixture of a pre-polymer 50-95% vol that will form the said low density polymer, and hollow microspheres in the range of from 5-50% vol;
iii) selectively depositing the admixture via a nozzle to form a layer, causing solidification of the polymer,
   repeating step iii) to form the device on the substrate wherein the syntactic foam has a density in the range of from 0.3 to 0.9 g/cm³

### FIELD

The present invention relates to the deposition of syntactic foams, more particularly to the formation of floatation devices for a vessel via layer wise selective deposition of syntactic foam.

### BACKGROUND

Syntactic foams are used as floatation devices for a body, such as ships, boats, maritime engineering platforms. The foams are typically filled into containers, which containers are then affixed to the body. Alternatively, syntactic foams are prepared in bulk and cut to shape, which are then affixed to the body.

### SUMMARY

According to an aspect of the present invention, there is provided a method of selectively depositing a syntactic foam, to provide a buoyancy device on a substrate, comprising the steps of:
i) selecting a low density polymer with a density in the range of from 0.8 to 1.2 g/cm³,
ii) forming an admixture of a pre-polymer 50-95% vol that will form the said low density polymer, and hollow microspheres in the range of from 5-50% vol;
iii) selectively depositing the admixture via a nozzle to form a layer, causing solidification of the polymer,
iv) repeating step iii) to form the device on the substrate wherein the syntactic foam has a density in the range of from 0.3 to 0.9 g/cm³.

The admixture of a pre-polymer may be a curable monomer (thermoplastic) or a thermoset polymer.

There is further provided a method of selectively depositing a syntactic foam, to provide a buoyancy device on a substrate, comprising the steps of:
i) selecting a low density polymer with a density in the range of from 0.8 to 1.2 g/cm³,
ii) forming an admixture of a monomer 50-95% vol that will form the said low density polymer, and hollow microspheres in the range of from 5-50% vol;
iii) selectively depositing the admixture via a nozzle to form layer, causing the cure of the admixture, iv) repeating step iii) to form the buoyancy device on the substrate, wherein the syntactic foam has a density in the range of 0.3 to 0.9 g/cm³.

The use of thermoset polymers typically require a monomer and a curative, such as for example a chemical hardener, thermal stimulus, radiation, such as for example UV or electron beam. The layer in step iii) needs to have cured to allow it to form a support for the subsequent layer to be deposited thereon. The step of curing may begin before leaving the nozzle, or the layer may be cured once deposited.

According to a further aspect of the invention there is provided a method of selectively depositing a syntactic foam, to provide a buoyancy device on a substrate, comprising the steps of
i) selecting a low density thermoplastic polymer with a density in the range of from 0.8 to 1.2 g/cm³,
ii) forming an admixture comprising a melt of the low density thermoplastic polymer 50-95% vol, and hollow microspheres in the range of 5-50% vol range;
iii) selectively depositing the admixture via a nozzle to form a layer, causing the layer to solidify (where the layer then solidifies).
v) repeating step iii) to form the buoyancy device on the substrate, wherein the syntactic foam has a density in the range of 0.3 to 0.9 g/cm³.

The step of causing the melt of the thermoplastic polymer, may be achieved by a heater, such as an electric heater, laser or water jacket, depending on the melting temperature of the selected thermoplastic polymer. The step of causing the cooling, may reduce to the temperature of the layer, such that it forms a solid layer capable of forming a support for the subsequent layer to be deposited thereon.

The rate of curing or solidification must be sufficiently quick such that after a first layer of material has been deposed, that the layer is solid such as to allow the next layer to be formed.

The step of selective deposition may include the step of selectively depositing the admixture to produce regions or absences of polymer, which may contain no syntactic foam, thereby causing a decrease in the density of the syntactic foam device.

The syntactic foam may have a density of less than 1 g/cm³, more preferably in the range of from 0.3 g/cm³-0.9 g/cm³, as low as possible while maintaining strength.

The thermoset polymer may be any thermoset polymer, such as for example polyurethane, epoxy resins, polyureas, polyamines, polyimides, silicone resins, and vinyl esters. Preferably epoxy resins.

The thermoplastics polymer may be selected from, Polyamide PA, polypropylene PP, high and low density polyethylene HDPE, LDPE, polyetherimide PEI, and polystyrenes. Preferably with densities as low as possible while maintaining strength.

The hollow microspheres maybe present in the range of from 5 vol % to 50 vol %, more preferably in the range of from 40-50 vol %.

The hollow microspheres may have an average diameter in the range of from 5 microns to 300 microns, to allow passage through the 3D printer nozzle.

The hollow microspheres may be made from any suitable materials, such as example glass, ceramic, polymer or metal spheres. The microspheres may be of fixed volume, or may be gas filled expanding microspheres, such that with the application of a thermal stimulus the microspheres expand to a larger volume, with a concomitant decrease in the density of the syntactic foam. Microspheres is a well-known term, and the shapes are generally spheroid, for example a sphere, an ovoid, a cylinder a prism, a polyhedron, a cone, a parallelepiped, a cube, a cuboid form, a pyramid, and prism and other oblate spheroid shapes are common. Preferably spheroid.

The microspheres may be uniformly distributed within the admixture, such that the syntactic foam device has uniform density across the device. Alternatively the microspheres may be provided at different volumes of inclusion within a layer such that the syntactic foam device has different regions of density therein. The density of the syntactic foam device may also be controlled by the selective non-deposition of the admixture, as defined hereinbefore.

The micro-elements may, for example, be dosed via a dosimetric pump

The syntactic foam device, may require regions of structural support, or reinforced areas, for example where the syntactic foam device may be secured to an element or body. The reinforcement may be the absence of the hollow spheres, such that there may be deposited regions containing only low density polymer. Alternatively reinforcement fillers, fibre plys, splines, may be introduced to the layers. The use of fillers, such as chopped fibres, particulate powders may be added to the admixture and selectively deposited where needed.

According to a further aspect of the invention there is provided a syntactic foam floatation apparatus, comprising
a low density polymer 50-95 vol % with a density in the range of from 0.8 to 1.2 g/cm³, and hollow spheres in the range of 5-50% vol range;
   characterised in that said flotation apparatus comprising a plurality of cavities with a void volume at least 10 vol % that contain no syntactic foam, wherein the syntactic foam has a density in the range of from 0.3 to 0.9 g/cm³.

According to a further aspect of the invention there is provided a vehicle vessel or craft comprising a layerwise deposited syntactic foam, said foam comprising:
a low density polymer 50-95 vol % with a density in the range of from 0.8 to 1.2 g/cm³, and hollow spheres in the range of 5-50% vol range;
   wherein the syntactic foam has a density in the range of from 0.3 to 0.9 g/cm³.

The admixture, may be directly applied to any substrate or device by means of either extrusion, deposition or spray process, e.g. via a nozzle printing. The substrate may be the 3D printer print bed, a vehicle, vessel or craft, such as a boat or ship. Additionally, in the domain of underwater equipment, such as offshore oil and gas production, flexible pipe and umbilicals require the use of buoyancy.

The substrate may be the printbed of the 3D printer, in-situ in a vessel, or any suitable surface. The syntactic foam may be deposited on a printbed forming the shape, removed from the 3D printing machine and then placed on the vessel.

Typically, floatation devices are prepared by casting large volumes of syntactic foam material which are then cut into panels in order to fit within a dedicated compartment. Alternatively, the floatation device is prepared within an outer container, to provide containment of the syntactic foam The selective deposition of the admixture allows the final shape to be built up for use on the vessel, without need for providing a container to house the syntactic foam, or for providing panels that require modification and cutting. Thereby reducing the processing time and material wastage.

Alternatively, the direct application of the admixture to a region of a boat or ship allows the floatation device to be directly built up on the structural member within the boat or ship.

The admixture may be applied and built up as a succession of layers, to provide the syntactic foam device. The successive layers may have different composition of admixture ie different percentage inclusion of microspheres.

Some embodiments relate to a process for making a syntactic foam including the steps below:

In one arrangement the admixture may be degassed.

Some are thermosetting plastics in which the term “resin” can be applied to the reactant or product, or both. “Resin” may be applied to one of two monomers in a copolymer (the other being called a “hardener”, as in epoxy resins). In case of epoxy resin, It may be chosen in the group including epoxy bisphenol A diglycidyl ether based resin, Bisphenol F epoxy resin, Novolac epoxy resin as epoxy phenol novolacs (EPN) and epoxy cresol novolacs (ECN), Aliphatic epoxy resin as glycidyl epoxy resins and cycloaliphatic epoxides, e.g. dodecanol glycidyl ether, diglycidyl ester of hexahydrophthalic acid or trimethylolpropane triglycidyl ether, Glycidylamine epoxy resin and methyl methacrylate resin.

Some are polyurethane resins which consist of a polymer composed of a chain of organic units joined by carbamate (urethane) links. They can be thermosetting polymers that do not melt when heated, or thermoplastic polyurethane resins.

Polymerisation initiators allow the setting or the beginning of the setting reaction of the curable liquid resin monomer or prepolymer. The polymerisation initiator may be selected depending on the kind of the curable liquid resin monomer. It can be selected in the group including polyfunctional amines, acids, acid anhydrides, phenols, alcohols, thiols, and polyols. For example, when the curable liquid resin monomer or prepolymer is polyurethane, the polymerization initiator may be polyol. When the liquid resin monomer or prepolymer is epoxy, the polymerization initiator may be a hardener; for example a polyfunctional amine, an acid, a phenol, an alcohol, or a thiol.

Mixing may be carried out at a temperature determined in order to obtain a suitable viscosity, i.e. a viscosity allowing mixing, and to control polymerisation. Advantageously, for thermoset polymers, the temperature is determined in order to limit and control the exothermic output of the curing step. For thermoset polymers the temperature is determined depending on the nature of the operable curable liquid resin, and possibly on the kind of the micro-elements. For thermoplastic polymers the temperature is determined by the melt temperature.

The formation of the admixture may be carried out by applying a mechanical force on the mixture including or consisting of operable curable liquid monomer/melt of thermoplastic and microspheres. The force may be selected from a shear force and a homogenization force resulting in less than about 15% of degradation or breakage of the microspheres. The means of applying the mechanical force may be any mean known by one of ordinary skill in the art.

### BRIEF DESCRIPTION OF THE FIGURES

Embodiments of the invention will now be described by way of example only with reference to the figures, in which:

FIG. 1 shows a deposition system with a mixing nozzle . . . ;

FIG. 2 shows a deposition with pre-mixed reservoir

FIG. 3 shows a curved substrate with deposited syntactic foam . . . ; and

FIG. 4 shows a substrate with deposited syntactic foam and regions of no foam.

### DETAILED DESCRIPTION

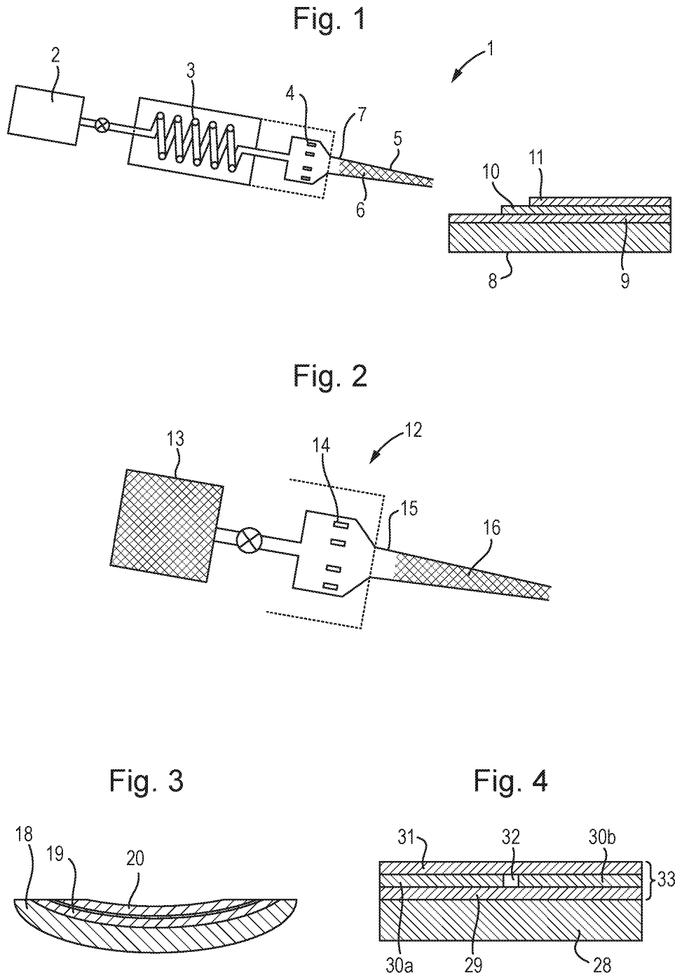

Turning to FIG. 1, shows a deposition system 1, which comprises a reservoir 2 of a curable monomer or (molten thermoplastic), the mixing chamber 3 provides an admixture with the monomer and microspheres 5, the admixture passes through a head 4, and a nozzle 7. The curing monomer/cooling thermoplastic 6 and microspheres are deposited layerwise 9-11, onto a substrate 8. The first layer 9 of the deposited material is deposited onto the substrate 8, and once cured and/or solid a second layer 10, and further layers to be built up. The layer wise deposition allows a floatation device to be built-up layer wise, such that the need to cut panels to size or to affix containers filled with a syntactic foam is removed.

Turning to FIG. 2, shows a deposition system 12, which comprises a reservoir 13 of an admixture of curable monomer or molten thermoplastic and microspheres, the admixture passes through a head 14, and a nozzle 15. The curing monomer/cooling thermoplastic 16 and microspheres are deposited layer wise onto a substrate as previously described.

Turning to FIG. 3, there is provided a curved substrate 18, which may be the hull of a ship or boat. The layerwise addition of first layer 19 and second layer 20 of syntactic foam allows for the contours of the hull to be adapted to, without complex cutting and affixing of panels of syntactic foam.

Turning to FIG. 4, there is provided a substrate 28, which may be the 3D printer print bed, the hull of a ship or boat. The layerwise addition of first layer 29, is followed by a second layer 30a, then a region of no syntactic foam 32, which is a void or cavity, and then the second layer continues 30b, to form a support for the third layer 31. The cavity 32, further reduces the density of the final syntactic foam structure 33.

1. A method of selectively depositing a syntactic foam, to provide a buoyancy device on a substrate, the method comprising:
selecting a low density polymer with a density in the range of from 0.8 to 1.2 g/cm³;
forming an admixture of a pre-polymer that will form the said low density polymer, and hollow microspheres, the pre-polymer present in the range of from 50-95% vol;
selectively depositing the admixture via a nozzle to form a layer, causing solidification of the polymer; and
repeating the selectively depositing to form the device on the substrate wherein the syntactic foam has a density in the range of from 0.3 to 0.9 g/cm³.

2. The method of according to claim 1, wherein the admixture is a curable monomer.

3. The method of according to claim 1, wherein the admixture is a low density thermoplastic polymer, and forming the admixture includes forming an admixture comprising a melt of the low density thermoplastic polymer.

4. The method according to claim 1, wherein selectively depositing the admixture includes selectively depositing the admixture to produce cavities containing no syntactic foam to decrease the density of the syntactic foam part.

5. The method according to claim 1, wherein the syntactic foam has a density in the range of 0.3 to 0.9 g/cm³.

6. The method according to claim 1, wherein the admixture is a thermoset is an epoxy resin polymer.

7. The method according to claim 1, wherein the low density polymer is selected from thermoplastics, polyamide (PA), polypropylene (PP), high density polyethylene (HDPE), low density polyethylene (LDPE), and polyetherimide (PEI).

8. The method according to claim 1, wherein the hollow microspheres are present in the range of from 5-50% vol.

9. The method according to claim 1, wherein the hollow microspheres have an average diameter in the range of 5 to 300 microns.

10. The method according to claim 1, wherein the hollow microspheres are glass, ceramic, polymer, or metal spheres.

11. A The method according to claim 10, wherein the microspheres are gas filled expanding microspheres.

12. The method according to claim 1, comprising depositing regions of reinforcement material containing only low density polymer.

13. A syntactic foam floatation apparatus, comprising a low density polymer 50-95% vol with a density in the range of from 0.8 to 1.2 g/cm³, and hollow spheres in the range of 5-50% vol, such that said flotation apparatus includes a plurality of cavities with a void volume of at least 10% vol that contain no syntactic foam, wherein the syntactic foam has a density in the range of from 0.3 to 0.9 g/cm³.

14. A vehicle vessel or craft comprising a layerwise deposited syntactic foam, said foam comprising:
a low density polymer 50-95% vol with a density in the range of from 0.8 to 1.2 g/cm³, and hollow spheres in the range of 5-50% vol range;
wherein the syntactic foam has a density in the range of from 0.3 to 0.9 g/cm³.

15. The vehicle vessel or craft comprising the layerwise deposited syntactic foam according to claim 14, said foam comprising regions of reinforcement material.

16. The vehicle vessel or craft comprising the layerwise deposited syntactic foam according to claim 15, wherein the regions of reinforcement material contain only low density polymer.

17. The vehicle vessel or craft comprising the layerwise deposited syntactic foam according to claim 15, wherein the regions of reinforcement material contain one or more of reinforcement fillers, fibre plys, splines, chopped fibres, and/or particulate powders.

18. The vehicle vessel or craft comprising the layerwise deposited syntactic foam according to claim 15, wherein said vessel or craft is a ship with a curved hull, and said foam conforms to curvature of hull.

19. The method according to claim 6, wherein the thermoset polymer is an epoxy resin.

20. The method according to claim 1, comprising depositing regions of reinforcement material.
